(19) United States
(12) Patent Application Publication
(10) Pub. No.: US 2026/0279861 A1
(43) Pub. Date: Sep. 17, 2026

(54) CONTROL METHOD FOR FUEL CELL SYSTEM

(71) Applicants: KABUSHIKI KAISHA TOYOTA CHUO KENKYUSHO, Nagakute-shi (JP); KABUSHIKI KAISHA TOYOTA JIDOSHOKKI, Kariya-shi (JP)

(72) Inventors: Norihiro FUKAYA, Nagakute-shi (JP); Takao WATANABE, Nagakute-shi (JP); Akira KUWAKI, Nagakute-shi (JP); Naoya TOMIMOTO, Kariya-shi (JP); Dai KURITA, Kariya-shi (JP)

(73) Assignees: KABUSHIKI KAISHA TOYOTA CHUO KENKYUSHO, Nagakute-shi (JP); KABUSHIKI KAISHA TOYOTA JIDOSHOKKI, Kariya-shi (JP)

(21) Appl. No.: 19/564,770

(22) Filed: Mar. 12, 2026

(30) Foreign Application Priority Data
Mar. 13, 2025 (JP) 2025-040604

(51) Int. Cl. H01M 8/04992; H01M 8/04664; H01M 8/04858

(52) U.S. Cl. CPC H01M 8/04992; H01M 8/04671; H01M 8/04873

(57) ABSTRACT

A control method for a fuel cell system including: an oxidation rate acquisition step of acquiring oxidation rate θ₁ on electrode catalyst of unit cell in the fuel cell; poisoning rate acquisition step of acquiring a poisoning rate θ₂ of electrode catalyst of unit cell in fuel cell; a normal operation step of performing a normal operation at a potential within a predetermined range; a low potential operation step of performing a low potential operation for removing an oxide at a potential lower than a lower limit of a potential range of normal operation when oxidation rate θ₁ on electrode catalyst exceeds a specified value ai; and a high potential operation step of performing a high potential operation for removing poisoning at a potential exceeding an upper limit of the potential range of the normal operation when the poisoning rate θ₂ of the electrode catalyst exceeds a specified value α₂.

### BACKGROUND OF THE INVENTION

### Field of the Invention

The present invention relates to a control method for a fuel cell system, and more specifically, relates to a control method for a fuel cell system that suppresses a decrease in power generation performance/recovers decreased power generation performance of a fuel cell based on a poisoning rate of an electrode catalyst of the fuel cell.

### Related Background Art

In a fuel cell, it is known that an electrode catalyst is poisoned by adhesion of impurities in/decomposition products of a reaction gas and a constituent member of the fuel cell to the electrode catalyst, and power generation performance decreases. For this reason, conventionally, methods for decomposing and removing poisoning substances of the electrode catalyst to suppress the decrease in the power generation performance/recover the decreased power generation performance of the fuel cell have been proposed.

For example, Japanese Unexamined Patent Application Publication No. 2020-181665 (Patent Literature 1) discloses a control method for a fuel cell system comprising: a first calculation step of calculating a poisoning rate of an electrode catalyst of a unit cell in the fuel cell; a second calculation step of calculating a generation rate of hydrogen peroxide from a value calculated in the first calculation step; and a step of not performing a potential fluctuation operation of repeating a potential of the unit cell in the fuel cell between a first value and a second value different from the first value when the calculated generation rate of hydrogen peroxide is smaller than a predetermined specified value α, or performing the potential fluctuation operation when the calculated generation rate of hydrogen peroxide is larger than the predetermined specified value α. Further, Japanese Unexamined Patent Application Publication No. 2022-178093 (Patent Literature 2) discloses a control method for a fuel cell system comprising: a step of acquiring a poisoning rate of an electrode catalyst of the unit cell in the fuel cell; a step of performing a potential maintenance operation of maintaining a potential of the unit cell in the fuel cell within a first potential range when the poisoning rate of the electrode catalyst exceeds a specified value α; and a step of performing, after the potential maintenance operation, a potential fluctuation operation of repeating a cycle of fluctuating the potential of the unit cell in the fuel cell between an upper limit potential and a lower limit potential of a second potential range in which the potential is higher than the first potential range.

In the methods described in Patent Literatures 1 to 2, the poisoning substances of the electrode catalyst are decomposed and removed by operation at a high potential during the potential fluctuation operation. However, when operating at a high potential, oxidation of catalyst metal particles of the electrode catalyst also proceeds. Oxidized catalyst metal particles not only cause deterioration of the electrode catalyst but also inhibit decomposition and removal of the poisoning substances of the electrode catalyst; therefore, it has been necessary to metallize or remove the oxidized catalyst metal particles. Therefore, since the oxidized catalyst metal particles can be metallized by operation at a low potential, in the methods described in Patent Literatures 1 to 2, compatible achievement of decomposition and removal of the poisoning substances of the electrode catalyst and metallization of the oxidized catalyst metal particles is attempted to suppress the decrease in the power generation performance/recover the decreased power generation performance of the fuel cell by performing the potential fluctuation operation of repeating the operation at a high potential and the operation at a low potential.

Furthermore, in the method described in Patent Literature 2, decomposition and removal efficiency of the poisoning substances of the electrode catalyst is improved by performing the potential maintenance operation before the potential fluctuation operation to metallize the oxidized catalyst metal particles and reduce adsorption force of the poisoning substances to the electrode catalyst. However, in the method described in Patent Literature 2, since whether or not to perform the potential maintenance operation is determined based on the poisoning rate of the electrode catalyst, the metallization of the oxidized catalyst metal particles is not necessarily sufficient, and there has been room for further improvement.

Moreover, as a method for removing an oxide film of an electrode catalyst, a method of determining whether or not to perform an oxide film removal treatment using an oxide film amount obtained based on a voltage of a single cell of a fuel cell, an impedance of the fuel cell, or a temperature of the fuel cell as an index is known (for example, Japanese Unexamined Patent Application Publication No. 2019-160478 (Patent Literature 3), Japanese Unexamined Patent Application Publication No. 2021-39897 (Patent Literature 4), and Japanese Unexamined Patent Application Publication No. 2018-156747 (Patent Literature 5)).

### SUMMARY OF THE INVENTION

However, when the potential fluctuation operation of repeating the operation at a high potential and the operation at a low potential is performed, there has been a problem that irreversible deterioration of the electrode catalyst occurs because catalyst metal particles such as platinum contained in the electrode catalyst undergo Ostwald growth. Further, although it is possible to decompose and remove more poisoning substances of the electrode catalyst and metallize the oxidized catalyst metal particles by increasing cycles of the potential fluctuation operation, there has been a problem that the irreversible deterioration of the electrode catalyst is liable to occur because the Ostwald growth of the catalyst metal particles is also promoted.

The present invention has been made in view of the problems possessed by the above prior art, and an object thereof is to provide a control method for a fuel cell system capable of achieving both decomposition and removal of poisoning substances of an electrode catalyst of a fuel cell and metallization of oxidized catalyst metal particles, and capable of suppressing Ostwald growth of catalyst metal particles.

In order to solve the above problems, the present invention provides the following aspects.
[1]A control method for a fuel cell system comprising:
   an oxidation rate acquisition step of acquiring an oxidation rate θ₁ on an electrode catalyst of a unit cell in the fuel cell;
   a poisoning rate acquisition step of acquiring a poisoning rate θ₂ of the electrode catalyst of the unit cell in the fuel cell;
   a normal operation step of performing a normal operation at a potential within a predetermined range;
   a low potential operation step of performing a low potential operation for removing an oxide at a potential lower than a lower limit of a potential range of the normal operation when the oxidation rate θ₁ on the electrode catalyst exceeds a specified value α₁; and
a high potential operation step of performing a high potential operation for removing poisoning at a potential exceeding an upper limit of the potential range of the normal operation when the poisoning rate θ₂ of the electrode catalyst exceeds a specified value α₂.
[2] The control method for a fuel cell system according to [1], wherein when both the low potential operation and the high potential operation are performed, the low potential operation is performed before performing the high potential operation.
[3] The control method for a fuel cell system according to [1] or [2], further comprising a deterioration rate acquisition step of acquiring a deterioration rate θ₃ of the electrode catalyst by predicting irreversible deterioration of the electrode catalyst of the unit cell in the fuel cell,
   wherein in the poisoning rate acquisition step, a voltage of the unit cell in the fuel cell is predicted from the oxidation rate θ₁ on the electrode catalyst and the deterioration rate θ₃ of the electrode catalyst, and the poisoning rate θ₂ of the electrode catalyst is estimated from a deviation value between an actually measured value and a predicted value of the voltage of the unit cell in the fuel cell.
[4] The control method for a fuel cell system according to [3], wherein in the oxidation rate acquisition step, a state of the oxide on the electrode catalyst is predicted by a model to acquire the oxidation rate θ₁ on the electrode catalyst.
[5] The control method for a fuel cell system according to [3] or [4], wherein the specified value α₁ is changed according to the poisoning rate θ₂ and the deterioration rate θ₃ of the electrode catalyst, and the specified value α₂ is changed according to the oxidation rate θ₁ on the electrode catalyst and the deterioration rate θ₃ of the electrode catalyst.
[6] The control method for a fuel cell system according to any one of [3] to [5], wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

According to the present invention, it is possible to achieve both decomposition and removal of poisoning substances of an electrode catalyst of a fuel cell and metallization of oxidized catalyst metal particles, and it becomes possible to suppress Ostwald growth of catalyst metal particles.

### BRIEF DESCRIPTION OF THE DRAWINGS

FIG. 1 is a schematic cross-sectional view of a catalyst metal particle on which an oxide film is formed.

FIG. 2 is a flowchart showing an example of a procedure for acquiring an oxidation rate θ₁ and a poisoning rate θ₂ and for performing low potential operation and high potential operation.

FIG. 3 is a flowchart showing another example of the procedure for acquiring the oxidation rate θ₁ and the poisoning rate θ₂ and for performing low potential operation and high potential operation.

FIG. 4 is a flowchart showing still another example of the procedure for acquiring the oxidation rate θ₁ and the poisoning rate θ₂ and for performing low potential operation and high potential operation.

FIG. 5 is a flowchart showing yet another example of the procedure for acquiring the oxidation rate θ₁ and the poisoning rate θ₂ and for performing low potential operation and high potential operation.

### DETAILED DESCRIPTION OF THE PREFERRED EMBODIMENTS

Hereinafter, the present invention will be described in detail based on preferred embodiments thereof.

The control method for a fuel cell system of the present invention comprises:
an oxidation rate acquisition step of acquiring an oxidation rate θ₁ on an electrode catalyst of a unit cell in the fuel cell;
a poisoning rate acquisition step of acquiring a poisoning rate θ₂ of the electrode catalyst of the unit cell in the fuel cell;
a normal operation step of performing a normal operation at a potential within a predetermined range;
a low potential operation step of performing a low potential operation for removing an oxide at a potential lower than a lower limit of a potential range of the normal operation when the oxidation rate θ₁ on the electrode catalyst exceeds a specified value α₁; and
a high potential operation step of performing a high potential operation for removing poisoning at a potential exceeding an upper limit of the potential range of the normal operation when the poisoning rate θ₂ of the electrode catalyst exceeds a specified value α₂.

Further, the control method for a fuel cell system of the present invention may further comprise a deterioration rate acquisition step of acquiring a deterioration rate θ₃ of the electrode catalyst by predicting irreversible deterioration of the electrode catalyst of the unit cell in the fuel cell.

First, each step in the control method for a fuel cell system of the present invention will be described.

### [Oxidation Rate Acquisition Step]

The oxidation rate acquisition step is a step of obtaining the oxidation rate θ₁ on the electrode catalyst of the unit cell in the fuel cell. There is no particular limitation on a method for obtaining the oxidation rate θ₁ on the electrode catalyst, and for example, as described in Japanese Unexamined Patent Application Publication No. 2019-160478, Japanese Unexamined Patent Application Publication No. 2021-39897, and Japanese Unexamined Patent Application Publication No. 2018-156747, the oxidation rate θ₁ on the electrode catalyst can be estimated from an impedance of the fuel cell, cyclic voltammetry, a reduction amount of a current at a specific voltage, or the like; however, from a viewpoint that it can be obtained more simply (for example, experimental facilities for estimation, preliminary experiments, and the like are unnecessary), it is preferable to obtain the oxidation rate θ₁ on the electrode catalyst by predicting a state of an oxide on the electrode catalyst by a model.

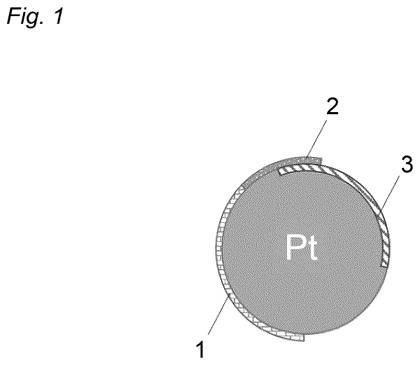

Specifically, as a catalyst metal particle, a particle model is considered in which, as shown in FIG. 1, a region 1 consisting of a hydroxide of a noble metal and a region 2 consisting of an oxide of the noble metal on a surface of the catalyst metal particle, and a region 3 consisting of several layers in which an oxide of the noble metal formed by oxygen atoms penetrating from the surface of the catalyst metal particle exists, are present. In this particle model, a sum of a ratio (θₒₓ₁) occupied by the hydroxide 1 of the noble metal and a ratio (θₒₓ₂) occupied by the oxide 2 of the noble metal with respect to the surface of the catalyst metal particle, and a ratio (θₒₓ₃) occupied by the oxide 3 of the noble metal with respect to the region of several layers from the surface of the catalyst metal particle is the oxidation rate θ₁ on the electrode catalyst.

In the catalyst metal particle in such a state, when a kinetic model based on a physical phenomenon (N. Fukaya et al., Electrochimica Acta, 2023, Vol. 464, 142867, Japanese Unexamined Patent Application Publication No. 2023-126025, and Japanese Unexamined Patent Application Publication No. 2024-148855) is applied, the oxidation rate θ₁(i) on the electrode catalyst at a calculation time i can be obtained by the following formulas.

$${θ}_{1} ( i ) = {θ}_{o x 1} ( i ) + {θ}_{o x 2} ( i ) + {θ}_{o x 3} ( i )$$

$${θ}_{o x 1} ( i ) = {θ}_{o x 1} ( i - 1 ) + Δ T \times \frac{{v}_{1} ( i ) - {v}_{2} ( i )}{Γ}$$

$${θ}_{o x 2} ( i ) = {θ}_{o x 2} ( i - 1 ) + Δ T \times \frac{{v}_{2} ( i ) - {v}_{3} ( i )}{Γ}$$

$${θ}_{o x 3} ( i ) = {θ}_{o x 3} ( i - 1 ) + Δ T \times \frac{{v}_{3} ( i )}{Γ}$$

$${v}_{1} ( i ) = {α}_{11} \{ ( 1 - {θ}_{o x 1} ( i - 1 ) - {θ}_{o x 2} ( i - 1 ) ) \times exp ( {α}_{12} \times {G}_{1} ( i ) ) - {θ}_{o x 1} ( i - 1 ) \times exp ( - {α}_{13} \times {G}_{1} ( i ) ) \}$$

$${v}_{2} ( i ) = {α}_{21} \{ {θ}_{o x 1} ( i - 1 ) \times exp ( {α}_{22} \times {G}_{2} ( i ) ) - {θ}_{o x 2} ( i - 1 ) \times exp ( - {α}_{23} \times {G}_{2} ( i ) ) \}$$

$${v}_{3} ( i ) = {α}_{31} \{ ( 1 - {θ}_{o x 3} ( i - 1 ) ) \times {θ}_{o x 2} ( i - 1 ) \times exp ( {α}_{32} \times {G}_{3} ( i ) ) - {θ}_{o x 3} ( i - 1 ) \times ( 1 - {θ}_{o x 1} ( i - 1 ) - {θ}_{o x 2} ( i - 1 ) ) \times exp ( - {α}_{33} \times {G}_{3} ( i ) ) \}$$

$${G}_{1} ( i ) = {V}_{c a t} ( i ) - {α}_{14} - {α}_{15} \times {θ}_{o x 1} ( i - 1 ) - {α}_{16} \times {θ}_{o x 2} ( i - 1 ) - {α}_{17} \times {θ}_{o x 3} ( i - 1 )$$

$${G}_{2} ( i ) = {V}_{c a t} ( i ) - {α}_{24} - {α}_{25} \times {θ}_{o x 1} ( i - 1 ) - {α}_{26} \times {θ}_{o x 2} ( i - 1 ) - {α}_{27} \times {θ}_{o x 3} ( i - 1 )$$

$${G}_{3} ( i ) = {V}_{c a t} ( i ) - {α}_{34} - {α}_{35} \times {θ}_{o x 1} ( i - 1 ) - {α}_{36} \times {θ}_{o x 2} ( i - 1 ) - {α}_{37} \times {θ}_{o x 3} ( i - 1 )$$

$${V}_{c a t} ( i ) = V ( i ) + I ( i ) \times R$$

In the above formulas,
θₒₓ₁(i), θₒₓ₂(i), and θₒₓ₃(i) represent oxidation rates θₒₓ₁, θₒₓ₂, and θₒₓ₃ at the calculation time i;
ΔT represents a calculation step time;
v(i) represents a reaction rate of formation/disappearance of the oxide or hydroxide of each noble metal at the calculation time i;
Γ represents a maximum surface covering oxygen amount (constant) per unit surface area;
G₁(i) to G₃(i) represent free energies of reactions of v₁(i) to v₃(i) at the calculation time i;
V_{cat}(i) represents a catalyst potential of a cathode electrode at the calculation time i;
V(i) represents the voltage of the unit cell in the fuel cell at the calculation time i;
I(i) represents a current of the unit cell in the fuel cell at the calculation time i;
R represents a resistance of the unit cell in the fuel cell; and
α₁₁ to α₃₇ are adaptation coefficients.

Specifically, ΔT represents a time from a calculation time i−1 to the calculation time i. A value of ΔT is not particularly limited, an optimal value can be set according to an objective, and the value is usually set in a range of 0.01 to 100 s.

It is preferable that α₁₁ to α₃₇ are respectively determined by fitting to test results obtained by actual current-voltage characteristics (IV characteristics), cyclic voltammetry (CV), linear sweep voltammetry, or the like.

It is preferable to directly measure R from a high-frequency impedance of 1 kHz or more or the like, but a constant obtained in advance may be used.

Therefore, when the voltage V(i) and the current I(i) at the calculation time i of the unit cell in the fuel cell are measured, the oxidation rate 01(i) on the electrode catalyst at the calculation time i can be sequentially obtained using the above formulas. Note that as initial values of respective oxidation rates, that is, oxidation rates (θₒₓ₁(0), θₒₓ₂(0), and θₒₓ₃(0)) at the calculation time i=0, values at a time of previous stop may be used, or when it can be assumed that the oxide of the noble metal or the like does not exist on the electrode catalyst (for example, when stopped during or immediately after the low potential operation), θₒₓ₁(0)=0, θₒₓ₂(0)=0, and θₒₓ₃(0)=0 may be set.

Further, when obtaining the oxidation rate θ₁ on the electrode catalyst, as described above, a model assuming three types of oxides may be used, but a model assuming one to two types of oxides or a model assuming four types of oxides may be used. When the types of oxides to be assumed are increased, degrees of freedom increase and calculation accuracy improves, but calculation load increases. On the other hand, when the types of oxides to be assumed are decreased, the calculation load is reduced, but the degrees of freedom and the calculation accuracy decrease.

### [Deterioration Rate Acquisition Step]

The deterioration rate acquisition step is a step of obtaining the deterioration rate θ₃ of the electrode catalyst by predicting irreversible deterioration of the electrode catalyst of the unit cell in the fuel cell. It is considered that the deterioration of the electrode catalyst is mainly caused by a decrease in an electrochemical surface area A_{ECS} due to coarsening of the catalyst metal particles of the cathode electrode (irreversible deterioration due to Ostwald growth of the catalyst metal particles). Therefore, in the present invention, the deterioration rate θ₃(i) of the electrode catalyst at the calculation time i is defined by the following formula.

$${θ}_{3} ( i ) = \frac{{A}_{ECS} ( i )}{{A}_{ECS}^{0}}$$

In the above formula,
A_{ECS}(i) represents the electrochemical surface area of the catalyst metal particles of the cathode electrode at the calculation time i, and
A_{ECS}⁰ represents an initial value of the electrochemical surface area of the catalyst metal particles of the cathode electrode.

As a method for estimating the electrochemical surface area A_{ECS}, for example, methods described in Japanese Unexamined Patent Application Publication No. 2023-126025 and Japanese Unexamined Patent Application Publication No. 2024-148855 can be used, and among them, it is preferable to estimate A_{ECS}(i) by any of the following formulas from a viewpoint that the method is a simpler method and calculation cost can be reduced.

$${A}_{E C S} ( i ) = {A}_{ECS}^{0} - {B}_{1} \times {\sum }_{0}^{i} Δ T$$

$${A}_{E C S} ( i ) = {A}_{ECS}^{0} - {B}_{1} \times {\sum }_{0}^{i} \{ Δ T \times ( 1 - {θ}_{1} ( i ) ) \times exp ( {B}_{2} \times ( {B}_{3} - {V}_{c a t} ( i ) ) ) \}$$

$${V}_{c a t} ( i ) = V ( i ) + I ( i ) \times R$$

In the above formulas,
A_{ECS}⁰ represents the initial value of the electrochemical surface area of the catalyst metal particles of the cathode electrode;
ΔT represents the calculation step time;
θ₁(i) represents the oxidation rate θ₁ at the calculation time i;
V_{cat}(i) represents the catalyst potential of the cathode electrode at the calculation time i;
V(i) represents the voltage of the unit cell in the fuel cell at the calculation time i;
I(i) represents the current of the unit cell in the fuel cell at the calculation time i;
R represents the resistance of the unit cell in the fuel cell; and
B₁ to B₃ are adaptation coefficients.

It is preferable that A_{ECS}⁰ and B₁ to B₃ are respectively determined by performing another power generation experiment in advance and fitting to test results thereof.

Therefore, when the voltage V(i) and the current I(i) at the calculation time i of the unit cell in the fuel cell are measured, the deterioration rate θ₃(i) of the electrode catalyst at the calculation time i can be sequentially obtained using the above formulas.

### [Poisoning Rate Acquisition Step]

The poisoning rate acquisition step is a step of obtaining the poisoning rate θ₂ of the electrode catalyst of the unit cell in the fuel cell. As a method for obtaining the poisoning rate θ₂ of the electrode catalyst, the poisoning rate θ₂ of the electrode catalyst may be estimated by actually measuring the performance (current and voltage) of the fuel cell as long as the measurement method can distinguish causes of a decrease in the performance (current and voltage) of the fuel cell into a cause due to poisoning of the electrode catalyst, a cause due to deterioration of the electrode catalyst (coarsening of the catalyst metal particles), and a cause due to oxidation of the electrode catalyst; however, normally, it is not easy to distinguish as described above. Therefore, taking into account the deterioration of the electrode catalyst due to the Ostwald growth of the catalyst metal particles and the decrease in a reaction area due to the oxidation of the electrode catalyst, it is preferable to calculate the poisoning rate θ₂ of the electrode catalyst by predicting the voltage of the unit cell in the fuel cell from the oxidation rate θ₁ on the electrode catalyst acquired in the oxidation rate acquisition step and the deterioration rate θ₃ of the electrode catalyst acquired in the deterioration rate acquisition step, and assuming that a deviation value between an estimated value of this voltage of the unit cell in the fuel cell and an actually measured voltage of the unit cell in the fuel cell is caused by the poisoning of the electrode catalyst.

The estimated value Vₑₛₜ(i) of the voltage of the unit cell in the fuel cell at the calculation time i can be estimated by the following formulas similarly to the method described in Japanese Unexamined Patent Application Publication No. 2023-126025. Note that in the uppermost formula below, a first term to a fourth term are terms corresponding to an open circuit electromotive voltage, an activation overvoltage, a concentration overvoltage, and a resistance overvoltage, respectively.

$${V}_{e s t} ( i ) = {V}_{OCV} - {C}_{1} \times log ( \frac{I ( i )}{{I}_{0} ( i )} ) - {C}_{2} \times log ( \frac{{C}_{3}}{{C}_{4} - {C}_{5} \times {R}_{g a s} ( i ) \times I ( i )} ) - {C}_{6} \times I ( i )$$

$${I}_{0} ( i ) = {C}_{7} \times ( 1 - {θ}_{1} ( i ) ) \times ( 1 - {θ}_{2} ( i ) ) \times {θ}_{3} ( i )$$

$${R}_{g a s} ( i ) = {C}_{8} + {C}_{9} \times {θ}_{3} ( i )$$

In the above formulas,
V_{OCV} represents the open circuit electromotive voltage of the fuel cell;
I(i) represents the current of the fuel cell at the calculation time i;
I₀(i) represents an exchange current density of the fuel cell at the calculation time i;
R_{gas}(i) represents a gas diffusion resistance of the fuel cell at the calculation time i;
θ₁(i) represents the oxidation rate θ₁ on the electrode catalyst at the calculation time i;
θ₂(i) represents the poisoning rate θ₂ of the electrode catalyst at the calculation time i;
θ₃(i) represents the deterioration rate θ₃ of the electrode catalyst at the calculation time i; and
C₁ to C₉ are adaptation coefficients.

It is preferable that V_{OCV} and C₁ to C₉ are respectively determined by performing another power generation experiment in advance and fitting to test results thereof.

Therefore, when the voltage V(i) and the current I(i) at the calculation time i of the unit cell in the fuel cell are measured, the voltage Vₑₛₜ(i) is estimated with θ₂(i)=0 in the above formula, and the deviation value between the voltage Vₑₛₜ(i) and the actually measured voltage V(i) is assumed to be caused by the poisoning of the electrode catalyst, the poisoning rate θ₂ of the electrode catalyst can be estimated from this deviation value.

Further, when a temperature T_{f}c(i), the high-frequency impedance R(i), a cathode air pressure P_{ca}(i), and a cathode air stoichiometry ST_{ca}(i) of the fuel cell at the calculation time i are measured during the measurement of the current I(i) and the voltage V(i) of the fuel cell, the formula for calculating the estimated value Vₑₛₜ(i) of the voltage of the unit cell in the fuel cell at the calculation time i can be improved in precision as represented by the following formulas.

$${V}_{e s t} ( i ) = {V}_{OCV} - {C}_{10} \times {T}_{fc} ( i ) \times log ( \frac{I ( i )}{{I}_{0} ( i )} ) - {C}_{11} \times {T}_{fc} ( i ) \times log ( \frac{{C}_{3}}{{C}_{O 2} ( i ) - {C}_{5} \times {R}_{g a s} ( i ) \times I ( i )} ) - {C}_{12} \times R ( i ) \times I ( i )$$

$${I}_{0} ( i ) = {C}_{7} \times ( 1 - {θ}_{1} ( i ) ) \times ( 1 - {θ}_{2} ( i ) ) \times {θ}_{3} ( i ) \times {e}^{\frac{{C}_{13}}{{T}_{f c} ( i )}}$$

$${R}_{g a s} ( i ) = \frac{{P}_{c a} ( i )}{{C}_{14}} + {C}_{9} \times {θ}_{3} ( i )$$

$${C}_{O 2} ( i ) = {C}_{15} \times \frac{{P}_{c a} ( i )}{{T}_{fc} ( i )} \times \frac{{C}_{16} + \frac{S {T}_{c a} ( i ) - 1}{S {T}_{c a} ( i )}}{2}$$

In the above formulas,
V_{OCV} represents the open circuit electromotive voltage of the fuel cell;
I(i) represents the current of the fuel cell at the calculation time i;
I₀(i) represents the exchange current density of the fuel cell at the calculation time i;
C_{O2}(i) represents an oxygen concentration of the fuel cell at the calculation time i;
R_{gas}(i) represents the gas diffusion resistance of the fuel cell at the calculation time i;
θ₁(i) represents the oxidation rate θ₁ on the electrode catalyst at the calculation time i;
θ₂(i) represents the poisoning rate θ₂ of the electrode catalyst at the calculation time i;
θ₃(i) represents the deterioration rate θ₃ of the electrode catalyst at the calculation time i; and
C₃, C₅, C₇, and C₉ to C₁₆ are adaptation coefficients.

It is preferable that C₃, C₅, C₇, and C₉ to C₁₆ are respectively determined by performing another power generation experiment in advance and fitting to test results thereof.

Further, a method for estimating the poisoning rate θ₂(i) of the electrode catalyst at the calculation time i of the fuel cell is not limited to the method using the above formulas, and other methods may be used. For example, a relationship between the oxidation rate θ₁, the poisoning rate θ₂ and the deterioration rate θ₃ of the electrode catalyst, and the current and the voltage of the fuel cell (further, operating conditions of the fuel cell such as temperature, gas flow rate, and pressure) may be experimentally acquired in advance to create an experimental map, and based on this experimental map, the poisoning rate θ₂ of the electrode catalyst may be estimated from actually measured values of the current and the voltage of the fuel cell. Further, a learning model may be created by machine learning or the like based on data experimentally acquired in advance, and this may be used instead of the experimental map.

### [Normal Operation Step]

The normal operation step is a step of performing normal operation of the fuel cell at a potential within a predetermined range. If the potential in the normal operation becomes higher than the predetermined range, irreversible deterioration of the electrode catalyst proceeds exponentially due to Ostwald growth of catalyst metal particles or the like. Also, if the fuel cell is operated at a high potential, since the range of current that can be drawn is limited, the electric power output obtainable from the fuel cell becomes minute, and when power consumption of other auxiliary component parts constituting the fuel cell system (for example, a compressor for sending air, a hydrogen supply pump, a cooling pump, etc.) is taken into account, the efficiency of the fuel cell system decreases. On the other hand, if the potential in the normal operation becomes lower than the predetermined range, the electric power output obtainable from the fuel cell for a given current decreases. This means that loss is large, which is not preferable in terms of heat generation due to the loss and decrease in power efficiency. Considering these points, although it depends on the type of electrode catalyst to be used, for example, in a fuel cell using a general platinum catalyst, it is preferable to control so as to perform the normal operation at a potential within a range of 0.6 to 0.8 V.

### [Low Potential Operation Step (Oxide Removal Step)]

The low potential operation step is a step of performing a low potential operation of the fuel cell at a potential lower than a lower limit V_{L} of the potential range of the normal operation to remove oxides on the electrode catalyst. Since the oxidation-reduction potential of the catalyst changes depending on the material, particle diameter, shape, etc. of the catalyst, it is preferable to appropriately determine the potential in the low potential operation according to the electrode catalyst to be used. For example, in a fuel cell using a general platinum catalyst as fine particles of several nm, since the oxidation-reduction potential is in the vicinity of 0.6 V, it is preferable to operate the fuel cell at a potential lower than this potential, whereby the oxides on the electrode catalyst are removed.

Also, when the deterioration rate θ₃ of the electrode catalyst increases, that is, when Ostwald growth proceeds, the particle diameter of the catalyst metal particles increases and the V_{L} also changes; therefore, it is necessary to change the potential in the low potential operation. Furthermore, when the poisoning rate θ₂ of the electrode catalyst increases, the potential at which poisoning substances desorb changes and the V_{L} also changes; therefore, it is necessary to change the potential in the low potential operation. Also, when the oxidation rate θ₁ on the electrode catalyst increases, the reduction potential changes and the V_{L} also changes; therefore, it is necessary to change the potential in the low potential operation. For example, it is effective to control the V_{L} as a function of the oxidation rate θ₁, the poisoning rate θ₂ and the deterioration rate θ₃ as follows.

$${V}_{L} = {D}_{1} + {D}_{2} \times {θ}_{1} + {D}_{3} \times {θ}_{2} + {D}_{4} \times {θ}_{3}$$

In the above formula, D₁ to D₄ are adaptation coefficients, and it is preferable that they are determined by performing another power generation experiment in advance and fitting to the test results thereof, respectively.

Although the operation time of such low potential operation is not particularly limited, since the removal of oxides proceeds relatively quickly, several seconds are sufficient. Also, the low potential operation may be terminated after confirming that the oxidation rate θ₁ on the electrode catalyst has become less than a preset specified value. Thereby, oxides can be removed more reliably.

There is no particular limitation on the method of the low potential operation, and examples thereof include a method of increasing current to charge a secondary battery or the like with surplus electric power, a method of decreasing the stoichiometry of the supplied oxidation gas, refresh control that instantaneously sweeps current, and the like.

### [High Potential Operation Step (Poisoning Substance Removal Step)]

The high potential operation step is a step of performing a high potential operation of the fuel cell at a potential exceeding an upper limit V_{H} of the potential range of the normal operation to remove poisoning of the electrode catalyst. The potential in the high potential operation is not particularly limited as long as it is a potential at which poisoning substances decompose; however, since the reaction potential of the catalyst changes depending on the material, particle diameter, shape, etc. of the catalyst, and poisoning substances flowing out from members differ depending on the molecular structure of the members and their decomposition potentials also differ, it is preferable to determine appropriately according to the electrode catalyst to be used. For example, in a fuel cell using a fluorine-based molecule containing sulfonic acid generally used as an electrolyte, or a fuel cell using a highly dispersed platinum nanoparticle catalyst where poisoning substances are Nafion-based, it is preferable to operate the fuel cell at a high potential exceeding 0.8 V, whereby the poisoning of the electrode catalyst is removed.

Also, when the oxidation rate θ₁ on the electrode catalyst, the poisoning rate θ₂ of the electrode catalyst and the deterioration rate θ₃ of the electrode catalyst change, it is considered that the decomposition potential of poisoning substances also changes; therefore, it is necessary to change the potential in the high potential operation. For example, it is effective to control the V_{H} as a function of the oxidation rate θ₁, the poisoning rate θ₂ and the deterioration rate θ₃ as follows.

$${V}_{H} = {D}_{5} + {D}_{6} \times {θ}_{1} + {D}_{7} \times {θ}_{2} + {D}_{8} \times {θ}_{3}$$

In the above formula, D₅ to D₈ are adaptation coefficients, and it is preferable that they are determined by performing another power generation experiment in advance and fitting to the test results thereof, respectively.

Although the operation time of such high potential operation is not particularly limited, since the removal of poisoning substances is not so fast, several minutes are necessary. Also, in the high potential operation, since oxides are generated on the electrode catalyst simultaneously with the removal of poisoning substances, the oxidation rate θ₁ on the electrode catalyst increases. When the oxidation rate θ₁ on the electrode catalyst increases, the removal of poisoning substances does not proceed sufficiently; therefore, when the oxidation rate θ₁ on the electrode catalyst exceeds a preset specified value, it is desirable to stop the high potential operation. Furthermore, the high potential operation may be terminated after confirming that the poisoning rate θ₂ of the electrode catalyst has become less than a preset specified value. Thereby, inadvertent high potential maintenance can be prevented, Ostwald growth of catalyst metal particles is suppressed, and durability of the electrode catalyst tends to improve.

There is no particular limitation on the method of the high potential operation, and examples thereof include a method of decreasing current to discharge insufficient electric power from a secondary battery or the like, a method of changing supplied gas conditions, and the like.

### <Control Method>

In the control method for a fuel cell system of the present invention, the oxidation rate θ₁ on the electrode catalyst of the unit cell in the fuel cell and the poisoning rate θ₂ of the electrode catalyst of the unit cell in the fuel cell are acquired in the oxidation rate acquisition step and the poisoning rate acquisition step, and using the oxidation rate θ₁ and the poisoning rate θ₂ as indices, it is determined which of the normal operation step, the low potential operation step, or the high potential operation step is to be performed, and implemented.

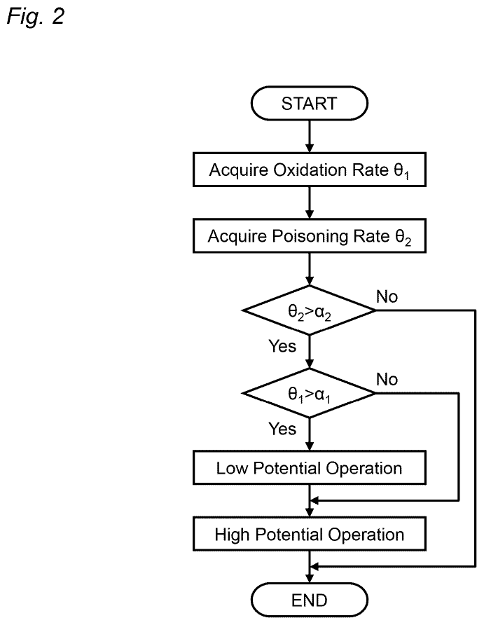

For example, as shown in the flowchart of FIG. 2, first, the oxidation rate θ₁ on the electrode catalyst is acquired in the oxidation rate acquisition step, and the poisoning rate θ₂ of the electrode catalyst is acquired in the poisoning rate acquisition step, respectively. Regarding the acquisition of the oxidation rate θ₁ and the poisoning rate θ₂, the poisoning rate θ₂ may be acquired after acquiring the oxidation rate θ₁ (FIG. 2), the oxidation rate θ₁ may be acquired after acquiring the poisoning rate θ₂, or the oxidation rate θ₁ and the poisoning rate θ₂ may be acquired simultaneously. Also, the oxidation rate θ₁ and the poisoning rate θ₂ to be acquired may be an instantaneous oxidation rate θ1(i) and poisoning rate θ₂(i) at a calculation time i, or may be an average oxidation rate θ₁ and an average poisoning rate θ₂ in a certain period.

Next, the necessity of the high potential operation step is determined using the poisoning rate θ₂ as an index. Specifically, as shown in the flowchart of FIG. 2, when the poisoning rate θ₂ exceeds a preset specified value α₂, it is judged that a decrease in catalyst performance due to poisoning is significant, and it is determined that the high potential operation step is necessary (“Yes” in FIG. 2), and when the poisoning rate θ₂ is equal to or less than the preset specified value α₂, it is judged that the catalyst performance is sufficient, and it is determined that the high potential operation step is unnecessary (“No” in FIG. 2). The specified value α₂ is set considering the balance between operation efficiency and durability of the fuel cell. If the specified value α₂ is set small, the number of executions of the high potential operation step increases, and there is a possibility that the fuel cell can be operated with high efficiency, but Ostwald growth of catalyst metal particles becomes liable to proceed. On the other hand, if the specified value α₂ is set large, Ostwald growth of catalyst metal particles tends to be suppressed, but since the high potential operation step is not performed even if the electrode catalyst is poisoned to some extent, poisoning substances are not removed, and there is a possibility that power generation efficiency decreases.

Also, since the removal efficiency of poisoning substances per one high potential operation step differs depending on the oxidation rate θ₁ and the deterioration rate θ₃ of the electrode catalyst, the specified value α₂ may be changed according to the oxidation rate θ₁ and the deterioration rate θ₃ of the electrode catalyst. For example, the specified value α₂ may be set as a function of the oxidation rate θ₁ and the deterioration rate θ₃ as follows.

$${α}_{2} = {E}_{1} + {E}_{2} \times {θ}_{1} + {E}_{3} \times {θ}_{3}$$

In the above formula, E₁ to E₃ are adaptation coefficients, and it is preferable that they are determined by performing another power generation experiment in advance and fitting to the test results thereof, respectively.

Next, as shown in the flowchart of FIG. 2, when it is determined in the above determination that the high potential operation step is unnecessary (“No” in FIG. 2), the normal operation step is performed without determining the necessity of the following low potential operation step. On the other hand, when it is determined that the high potential operation step is necessary (“Yes” in FIG. 2), the necessity of the low potential operation step is determined using the oxidation rate θ₁ as an index.

Specifically, as shown in the flowchart of FIG. 2, when the oxidation rate θ₁ exceeds a preset specified value α₁, it is judged that the removal of poisoning substances is inhibited by oxides, and it is determined that the low potential operation step is necessary (“Yes” in FIG. 2), and when the oxidation rate θ₁ is equal to or less than the preset specified value α₁, it is judged that poisoning substances are sufficiently removed by the high potential operation step even without removing oxides, and it is determined that the low potential operation step is unnecessary (“No” in FIG. 2). The specified value α₁ is set considering the balance between operation efficiency and durability of the fuel cell. If the specified value α₁ is set small, the number of executions of the low potential operation step increases, and oxides are sufficiently removed, so there is a possibility that poisoning substances can be removed with high efficiency, but Ostwald growth of catalyst metal particles becomes liable to proceed. On the other hand, if the specified value α₁ is set large, Ostwald growth of catalyst metal particles tends to be suppressed, but since the low potential operation step is not performed even if the electrode catalyst is oxidized to some extent, oxides are not sufficiently removed, and there is a possibility that the removal efficiency of poisoning substances decreases.

Also, since the removal efficiency of poisoning substances per one low potential operation step differs depending on the poisoning rate θ₂ and the deterioration rate θ₃ of the electrode catalyst, the specified value α₁ may be changed according to the poisoning rate θ₂ and the deterioration rate θ₃ of the electrode catalyst. For example, the specified value α₁ may be set as a function of the poisoning rate θ₂ and the deterioration rate θ₃ as follows.

$${α}_{1} = {E}_{4} + {E}_{5} \times {θ}_{2} + {E}_{6} \times {θ}_{3}$$

In the above formula, E₄ to E₆ are adaptation coefficients, and it is preferable that they are determined by performing another power generation experiment in advance and fitting to the test results thereof, respectively.

Next, as shown in the flowchart of FIG. 2, when it is determined in the above determination that the low potential operation step is unnecessary (“No” in FIG. 2), the high potential operation step is performed without performing the low potential operation step. On the other hand, when it is determined that the low potential operation step is necessary (“Yes” in FIG. 2), the high potential operation step is performed after performing the low potential operation step.

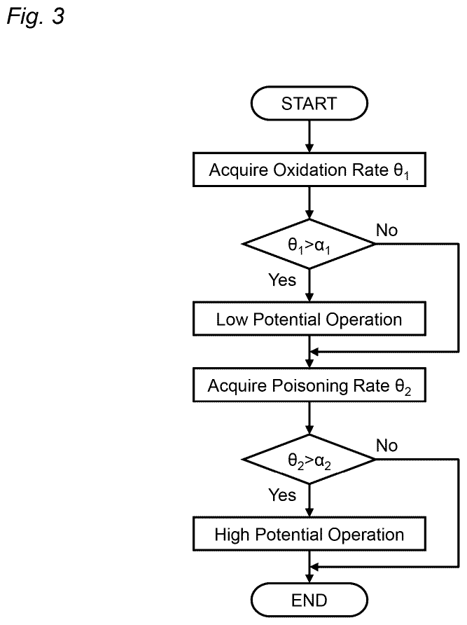

Also, in the control method for a fuel cell system of the present invention, the oxidation rate θ₁ on the electrode catalyst of the unit cell in the fuel cell and the poisoning rate θ₂ of the electrode catalyst of the unit cell in the fuel cell may be acquired in the oxidation rate acquisition step and the poisoning rate acquisition step by the procedure shown in the flowchart of FIG. 3, and using the oxidation rate θ₁ and the poisoning rate θ₂ as indices, it may be determined which of the normal operation step, the low potential operation step, or the high potential operation step is to be performed, and implemented.

That is, as shown in the flowchart of FIG. 3, first, the oxidation rate θ₁ on the electrode catalyst is acquired in the oxidation rate acquisition step. The oxidation rate θ₁ to be acquired may be an instantaneous oxidation rate θ₁(i) at a calculation time i, or may be an average oxidation rate θ₁ in a certain period.

Next, the necessity of the low potential operation step is determined using the oxidation rate θ₁ as an index. Specifically, as shown in the flowchart of FIG. 3, when the oxidation rate θ₁ exceeds a preset specified value α₁, it is judged that the removal of poisoning substances is inhibited by oxides, and it is determined that the low potential operation step is necessary (“Yes” in FIG. 3), and when the oxidation rate θ₁ is equal to or less than the preset specified value α₁, it is judged that poisoning substances are sufficiently removed by the high potential operation step even without removing oxides, and it is determined that the low potential operation step is unnecessary (“No” in FIG. 3). The specified value α₁ is the same as above.

Next, as shown in the flowchart of FIG. 3, when it is determined in the above determination that the low potential operation step is unnecessary (“No” in FIG. 3), the process proceeds to the next poisoning rate acquisition step without performing the low potential operation step. On the other hand, when it is determined that the low potential operation step is necessary (“Yes” in FIG. 3), the low potential operation step is performed, and thereafter, the process proceeds to the next poisoning rate acquisition step.

Next, as shown in the flowchart of FIG. 3, the poisoning rate θ₂ of the electrode catalyst is acquired in the poisoning rate acquisition step. The poisoning rate θ₂ to be acquired may be an instantaneous poisoning rate θ₂(i) at a calculation time i, or may be an average poisoning rate θ₂ in a certain period.

Next, the necessity of the high potential operation step is determined using the poisoning rate θ₂ as an index. Specifically, as shown in the flowchart of FIG. 3, when the poisoning rate θ₂ exceeds a preset specified value α₂, it is judged that a decrease in catalyst performance due to poisoning is significant, and it is determined that the high potential operation step is necessary (“Yes” in FIG. 3), and when the poisoning rate θ₂ is equal to or less than the preset specified value α₂, it is judged that the catalyst performance is sufficient, and it is determined that the high potential operation step is unnecessary (“No” in FIG. 3). The specified value α₂ is the same as above.

Next, as shown in the flowchart of FIG. 3, when it is determined in the above determination that the high potential operation step is unnecessary (“No” in FIG. 3), the normal operation step is performed. On the other hand, when it is determined that the high potential operation step is necessary (“Yes” in FIG. 3), the high potential operation step is performed.

In the procedures shown in the flowcharts of FIGS. 2 and 3, after performing the high potential operation step, the normal operation may be performed; however, it is preferable to repeatedly perform the above determination, the high potential operation step, and if necessary, the low potential operation step until the poisoning rate θ₂ becomes equal to or less than the specified value α₂, that is, until poisoning substances of the electrode catalyst can be sufficiently removed, and thereafter perform the normal operation.

Also, among the procedures shown in the flowcharts of FIGS. 2 and 3, the procedure shown in the flowchart of FIG. 2 is preferable. The procedure shown in the flowchart of FIG. 3 has a possibility that the low potential operation step is performed (when the oxidation rate θ₁ exceeds the specified value α₁) even when the high potential operation step is not performed (when the poisoning rate θ₂ is equal to or less than the specified value α₂), which is not preferable.

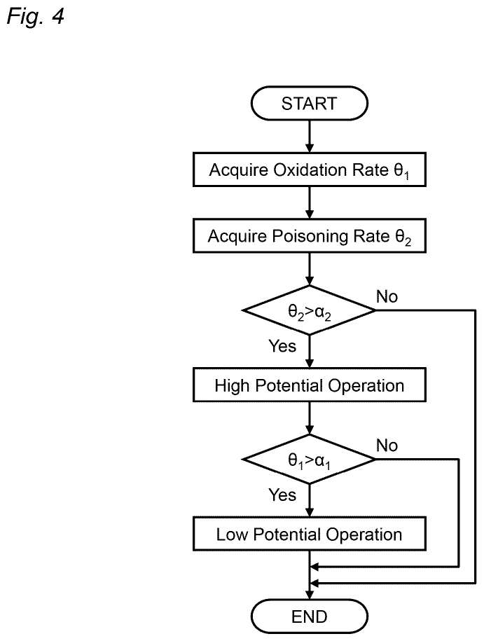

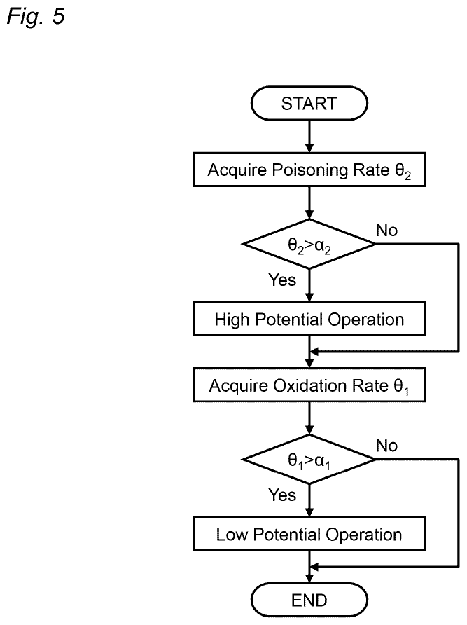

In the control method for a fuel cell system of the present invention, when performing both the low potential operation and the high potential operation, from the viewpoint that removal efficiency of poisoning substances improves, it is preferable to perform the low potential operation before performing the high potential operation as shown in the flowcharts of FIGS. 2 and 3; however, as shown in the flowcharts of FIGS. 4 and 5, the low potential operation may be performed after performing the high potential operation.

That is, in the procedure shown in the flowchart of FIG. 4, first, the oxidation rate θ₁ on the electrode catalyst is acquired in the oxidation rate acquisition step, and the poisoning rate θ₂ of the electrode catalyst is acquired in the poisoning rate acquisition step, respectively. Regarding the acquisition of the oxidation rate θ₁ and the poisoning rate θ₂, the poisoning rate θ₂ may be acquired after acquiring the oxidation rate θ₁ (FIG. 4), the oxidation rate θ₁ may be acquired after acquiring the poisoning rate θ₂, or the oxidation rate θ₁ and the poisoning rate θ₂ may be acquired simultaneously. Also, the oxidation rate θ₁ and the poisoning rate θ₂ to be acquired may be an instantaneous oxidation rate θ₁(i) and poisoning rate θ₂(i) at a calculation time i, or may be an average oxidation rate θ₁ and an average poisoning rate θ₂ in a certain period.

Next, the necessity of the high potential operation step is determined using the poisoning rate θ₂ as an index. Specifically, as shown in the flowchart of FIG. 4, when the poisoning rate θ₂ exceeds a preset specified value α₂, it is judged that a decrease in catalyst performance due to poisoning is significant, and it is determined that the high potential operation step is necessary (“Yes” in FIG. 4), and when the poisoning rate θ₂ is equal to or less than the preset specified value α₂, it is judged that the catalyst performance is sufficient, and it is determined that the high potential operation step is unnecessary (“No” in FIG. 4). The specified value α₂ is the same as above.

Next, as shown in the flowchart of FIG. 4, when it is determined in the above determination that the high potential operation step is unnecessary (“No” in FIG. 4), the normal operation step is performed without performing the high potential operation step and without determining the necessity of the following low potential operation step. On the other hand, when it is determined that the high potential operation step is necessary (“Yes” in FIG. 4), the high potential operation step is performed, and thereafter, the necessity of the low potential operation step is determined using the oxidation rate θ₁ as an index.

Specifically, as shown in the flowchart of FIG. 4, when the oxidation rate θ₁ exceeds a preset specified value ai, it is judged that the removal of poisoning substances is inhibited by oxides, and it is determined that the low potential operation step is necessary (“Yes” in FIG. 4), and when the oxidation rate θ₁ is equal to or less than the preset specified value α₁, it is judged that the influence of oxides in the next high potential operation step is small, and it is determined that the low potential operation step is unnecessary (“No” in FIG. 4). The specified value α₁ is the same as above.

Next, as shown in the flowchart of FIG. 4, when it is determined in the above determination that the low potential operation step is unnecessary (“No” in FIG. 4), the normal operation may be performed without performing the low potential operation step; however, it is preferable to repeatedly perform the above determination, the high potential operation step, and if necessary, the low potential operation step until the poisoning rate θ₂ becomes equal to or less than the specified value α₂, that is, until poisoning substances of the electrode catalyst can be sufficiently removed, and thereafter perform the normal operation. On the other hand, when it is determined that the low potential operation step is necessary (“Yes” in FIG. 4), the low potential operation step is performed. After performing the low potential operation step, the normal operation may be performed; however, it is preferable to repeatedly perform the above determination, the high potential operation step, and if necessary, the low potential operation step until the poisoning rate θ₂ becomes equal to or less than the specified value α₂, that is, until poisoning substances of the electrode catalyst can be sufficiently removed, and thereafter perform the normal operation.

Also, in the procedure shown in the flowchart of FIG. 5, first, the poisoning rate θ₂ of the electrode catalyst is acquired in the poisoning rate acquisition step. The poisoning rate θ₂ to be acquired may be an instantaneous poisoning rate θ₂(i) at a calculation time i, or may be an average poisoning rate θ₂ in a certain period.

Next, the necessity of the high potential operation step is determined using the poisoning rate θ₂ as an index. Specifically, as shown in the flowchart of FIG. 5, when the poisoning rate θ₂ exceeds a preset specified value α₂, it is judged that a decrease in catalyst performance due to poisoning is significant, and it is determined that the high potential operation step is necessary (“Yes” in FIG. 5), and when the poisoning rate θ₂ is equal to or less than the preset specified value α₂, it is judged that the catalyst performance is sufficient, and it is determined that the high potential operation step is unnecessary (“No” in FIG. 5). The specified value α₂ is the same as above.

Next, as shown in the flowchart of FIG. 5, when it is determined in the above determination that the high potential operation step is unnecessary (“No” in FIG. 5), the normal operation step is performed. On the other hand, when it is determined that the high potential operation step is necessary (“Yes” in FIG. 5), the high potential operation step is performed.

Next, the oxidation rate θ₁ on the electrode catalyst is acquired in the oxidation rate acquisition step. The oxidation rate θ₁ to be acquired may be an instantaneous oxidation rate θ₁(i) at a calculation time i, or may be an average oxidation rate θ₁ in a certain period.

Next, the necessity of the low potential operation step is determined using the oxidation rate θ₁ as an index. Specifically, as shown in the flowchart of FIG. 5, when the oxidation rate θ₁ exceeds a preset specified value α₁, it is judged that the removal of poisoning substances is inhibited by oxides, and it is determined that the low potential operation step is necessary (“Yes” in FIG. 5), and when the oxidation rate θ₁ is equal to or less than the preset specified value α₁, it is judged that poisoning substances are sufficiently removed by the high potential operation step even without removing oxides, and it is determined that the low potential operation step is unnecessary (“No” in FIG. 5). The specified value α₁ is the same as above.

Next, as shown in the flowchart of FIG. 5, when it is determined in the above determination that the low potential operation step is unnecessary (“No” in FIG. 5), the normal operation may be performed without performing the low potential operation step; however, it is preferable to repeatedly perform the above determination, the high potential operation step, and if necessary, the low potential operation step until the poisoning rate θ₂ becomes equal to or less than the specified value α₂, that is, until poisoning substances of the electrode catalyst can be sufficiently removed, and thereafter perform the normal operation. On the other hand, when it is determined that the low potential operation step is necessary (“Yes” in FIG. 5), the normal operation may be performed after performing the low potential operation step; however, it is preferable to repeatedly perform the above determination, the high potential operation step, and if necessary, the low potential operation step until the poisoning rate θ₂ becomes equal to or less than the specified value α₂, that is, until poisoning substances of the electrode catalyst can be sufficiently removed, and thereafter perform the normal operation.

Such control of the fuel cell system may be performed at each control cycle of the normal operation, or may be performed at arbitrary time intervals. Also, the control of the fuel cell system may be performed when an apparatus or facility incorporating the fuel cell system satisfies a specific condition. For example, the control of the fuel cell system may be performed when starting or stopping the fuel cell system, when a vehicle incorporating the fuel cell system enters a specific state (for example, vehicle speed is 0 km/h or 60 km/h), or when a load request to the fuel cell system enters a specific state (for example, the requested power is 0 W or several thousand W).

As described above, according to the present invention, it is possible to achieve both decomposition and removal of poisoning substances of an electrode catalyst of a fuel cell and metallization of oxidized catalyst metal particles, and it becomes possible to suppress Ostwald growth of catalyst metal particles.

Therefore, the control method for a fuel cell system of the present invention is useful as a control method for a fuel cell system in an apparatus or facility (for example, a fuel cell vehicle) incorporating the fuel cell system.

What is claimed is:

1. A control method for a fuel cell system comprising:
an oxidation rate acquisition step of acquiring an oxidation rate θ₁ on an electrode catalyst of a unit cell in the fuel cell;
a poisoning rate acquisition step of acquiring a poisoning rate θ₂ of the electrode catalyst of the unit cell in the fuel cell;
a normal operation step of performing a normal operation at a potential within a predetermined range;
a low potential operation step of performing a low potential operation for removing an oxide at a potential lower than a lower limit of a potential range of the normal operation when the oxidation rate θ₁ on the electrode catalyst exceeds a specified value α₁; and
a high potential operation step of performing a high potential operation for removing poisoning at a potential exceeding an upper limit of the potential range of the normal operation when the poisoning rate θ₂ of the electrode catalyst exceeds a specified value α₂.

2. The control method for a fuel cell system according to claim 1, wherein when both the low potential operation and the high potential operation are performed, the low potential operation is performed before performing the high potential operation.

3. The control method for a fuel cell system according to claim 1, further comprising a deterioration rate acquisition step of acquiring a deterioration rate θ₃ of the electrode catalyst by predicting irreversible deterioration of the electrode catalyst of the unit cell in the fuel cell,
wherein in the poisoning rate acquisition step, a voltage of the unit cell in the fuel cell is predicted from the oxidation rate θ₁ on the electrode catalyst and the deterioration rate θ₃ of the electrode catalyst, and the poisoning rate θ₂ of the electrode catalyst is estimated from a deviation value between an actually measured value and a predicted value of the voltage of the unit cell in the fuel cell.

4. The control method for a fuel cell system according to claim 2, further comprising a deterioration rate acquisition step of acquiring a deterioration rate θ₃ of the electrode catalyst by predicting irreversible deterioration of the electrode catalyst of the unit cell in the fuel cell,
wherein in the poisoning rate acquisition step, a voltage of the unit cell in the fuel cell is predicted from the oxidation rate θ₁ on the electrode catalyst and the deterioration rate θ₃ of the electrode catalyst, and the poisoning rate θ₂ of the electrode catalyst is estimated from a deviation value between an actually measured value and a predicted value of the voltage of the unit cell in the fuel cell.

5. The control method for a fuel cell system according to claim 3, wherein in the oxidation rate acquisition step, a state of the oxide on the electrode catalyst is predicted by a model to acquire the oxidation rate θ₁ on the electrode catalyst.

6. The control method for a fuel cell system according to claim 4, wherein in the oxidation rate acquisition step, a state of the oxide on the electrode catalyst is predicted by a model to acquire the oxidation rate θ₁ on the electrode catalyst.

7. The control method for a fuel cell system according to claim 3, wherein the specified value α₁ is changed according to the poisoning rate θ₂ and the deterioration rate θ₃ of the electrode catalyst, and the specified value α₂ is changed according to the oxidation rate θ₁ on the electrode catalyst and the deterioration rate θ₃ of the electrode catalyst.

8. The control method for a fuel cell system according to claim 4, wherein the specified value α₁ is changed according to the poisoning rate θ₂ and the deterioration rate θ₃ of the electrode catalyst, and the specified value α₂ is changed according to the oxidation rate θ₁ on the electrode catalyst and the deterioration rate θ₃ of the electrode catalyst.

9. The control method for a fuel cell system according to claim 5, wherein the specified value α₁ is changed according to the poisoning rate θ₂ and the deterioration rate θ₃ of the electrode catalyst, and the specified value α₂ is changed according to the oxidation rate θ₁ on the electrode catalyst and the deterioration rate θ₃ of the electrode catalyst.

10. The control method for a fuel cell system according to claim 6, wherein the specified value α₁ is changed according to the poisoning rate θ₂ and the deterioration rate θ₃ of the electrode catalyst, and the specified value α₂ is changed according to the oxidation rate θ₁ on the electrode catalyst and the deterioration rate θ₃ of the electrode catalyst.

11. The control method for a fuel cell system according to claim 3, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

12. The control method for a fuel cell system according to claim 4, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

13. The control method for a fuel cell system according to claim 5, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

14. The control method for a fuel cell system according to claim 6, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

15. The control method for a fuel cell system according to claim 7, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

16. The control method for a fuel cell system according to claim 8, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

17. The control method for a fuel cell system according to claim 9, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.

18. The control method for a fuel cell system according to claim 10, wherein a lower limit V_{L} and an upper limit V_{H} of the potential range of the normal operation are changed according to the oxidation rate θ₁ on the electrode catalyst, the poisoning rate θ₂ of the electrode catalyst, and the deterioration rate θ₃ of the electrode catalyst.
